(19) United States
(12) Patent Application Publication
(10) Pub. No.: US 2005/0039992 A1
(43) Pub. Date: Feb. 24, 2005

(54) Brake lining with damping layer

(76) Inventor: Aleksander Hurwic, Paris (FR)

Correspondence Address: Leo H McCormick;Bosch Braking Systems, 2112 Mishawaka Avenue, P O Box 4721, South Bend, IN, 46634-4721, US

(21) Appl. No.: 10/499,894

(22) PCT Filed: Dec. 30, 2002
(86) PCT No.: PCT/FR02/04593

(30) Foreign Application Priority Data
Dec. 31, 2001 (FR) 01/17110

(51) Int. Cl. F16D 65/38

(52) U.S. Cl. 188/73.35

(57) ABSTRACT

A brake device in particular for a motor vehicle, said brake device comprising pads (12) made of a friction material and serving to be clamped against a moving element (10), the pads (12) being carried by support pieces (14) via metal dampers (16) formed by knitted stainless steel wire compressed in a press, said dampers making it possible to absorb the resonant vibration modes of the brake disk.

The present invention relates to brake devices in particular for motor vehicles, such brake devices comprising pads made of a friction material and serving to be clamped against moving elements, such as brake disks constrained to rotate with the wheels of the vehicle.

In disk brakes of the floating caliper type, each disk extends between two brake pads which are fixed to metal supports and which are clamped against the disk by means of a hydraulic actuator mechanism comprising a piston that acts against one of the pads and a deflector caliper that acts on the other pad.

Braking can generate various levels of noise due to the friction between pads and the disk and to the disk vibrating under the effect of that friction.

A particular object of the invention is to provide a solution for solving that problem at least in part.

To this end, the invention proposes a brake device comprising at least one pad made of a friction material and serving to be pressed by a control member against a moving element such as, for example, a brake disk on a motor vehicle wheel, said brake device being characterized in that it further comprises a damper made of a tangled, intertwined and/or knitted metal wire interposed between the pad and the control member.

This metal damper, which is advantageously constituted by a block of tangled, intertwined, or knitted stainless steel wire that is compressed in a press, makes it possible to absorb the resonant vibration modes of the brake disk and significantly reduces the braking noise.

Metal dampers of that type have many advantages, such as the following: they are relatively insensitive to corrosion and to temperature variations (they withstand temperatures ranging from −70° C. to +300° C. without their characteristics being modified), they have low resonant frequencies, which makes it possible to attenuate very considerably the vibration modes of a brake disk, and they withstand static and dynamic loads that are relatively high or very high, which guarantees that they have long lives even when subjected to intense and repeated braking.

In a first embodiment of the invention, the metal damper is placed between the pad and a support piece for supporting said pad.

In which case, the control member, such as a piston or a deflector caliper, acts on the support piece, and the vibration of the disk is absorbed by the metal damper disposed between the pad and the supporting piece.

In another embodiment of the invention, the metal damper is disposed between the control member and a support piece for supporting the pad.

In which case, it may be secured to or integral with the support piece or mounted in part inside a recess in the support piece or in the control member.

In yet another embodiment of the invention, said metal damper may serve as a support piece for supporting the brake pad.

In general, the invention makes it possible to reduce significantly braking noise due to the vibration modes of the brake disk, and to do so simply, effectively, and inexpensively.

The invention will be better understood and other characteristics, details, and advantages thereof will appear more clearly on reading the following description which is given by way of example, and with reference to the accompanying drawing, in which:

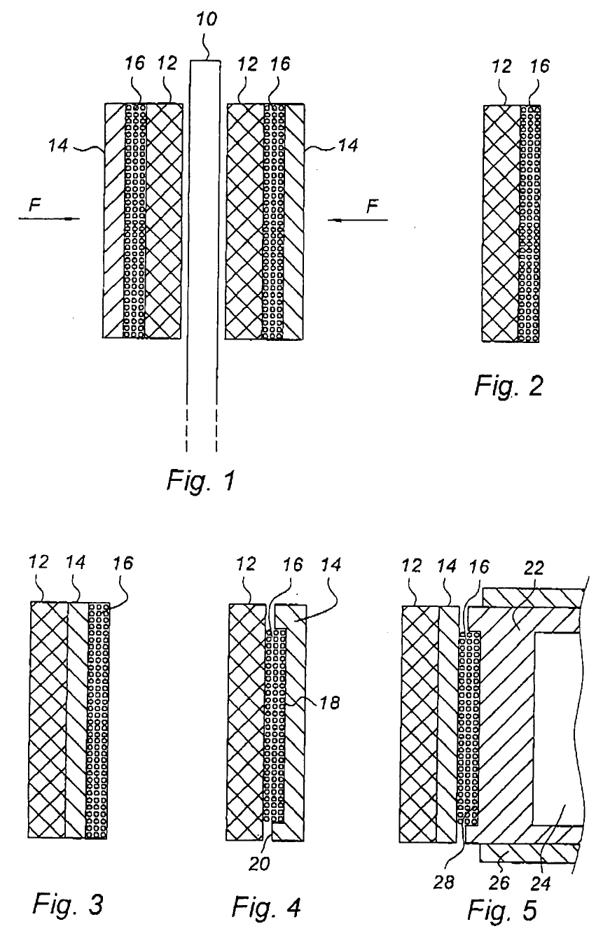

FIG. 1 is a diagrammatic fragmentary section view of a brake device of the invention; and

FIGS. 2 to 5 diagrammatically show variant embodiments of the invention.

In FIG. 1, reference 10 designates a brake disk which is constrained to rotate with a vehicle wheel (not shown) and which extends between brake pads 12 which are in mutual axial alignment and which are situated on either side of the disk 10, said pads 12 being mounted in a brake mechanism (not shown) that is well known to the person skilled in the art, and being clamped against the disk 10 to slow its rotation down or stop it from rotating when they are subjected to forces F generated in the brake mechanism by hydraulic fluid under pressure.

In the invention, each of the brake pads 12, made of a friction material of conventional type, is mounted on a respective support piece 14, e.g. made of metal, via a respective metal damper 16 formed of metal wire, and preferably stainless steel wire, which is tangled, intertwined, or knitted, and which is compressed in a press. The wire has a large contact area for providing damping by friction when the damper 16 is deformed, in particular by the vibration that is generated by braking.

Metal dampers of this type can withstand high static and dynamic loads while being compact, and they have resonant frequencies that are relatively low, lying in the range 15 hertz (Hz) to 25 Hz as a function of their dimensions and of their types. For example, a damper 16 having a thickness lying in the range 15 millimeters (mm) to 20 mm can withstand a static load lying in the range 50 decanewtons (daN) to 300 daN and a dynamic load of about 1000 daN, for example, its resonant frequency lying in the range 15 Hz to 20 Hz.

Such metal dampers made of stainless steel have excellent resistance to oils, to grease, to solvents, to water, to dust, and to chemicals. They are rated to withstand temperatures ranging from −70° C. to +300° C., they age very well, and they are capable of very considerably attenuating frequencies higher than their resonant frequency. Their compression elastic limit is 3 to 4 times higher than the maximum static load indicated above.

In the variant embodiment shown in FIG. 2, the brake pad 12 is fixed directly to the metal damper 16 which then replaces the support piece 14.

In the variant embodiment shown in FIG. 3, the brake pad 12 is fixed conventionally to the support piece 14, and the metal damper 16 is also fixed to the support piece 14, on the side opposite from the brake pad 12.

In the variant embodiment shown in FIG. 4, the metal damper 16 is disposed between the brake pad 12 and the support piece 14 and, at rest, it is received in part in a recess 18 formed in the support piece 14, on the same side of said piece as the side on which the brake pad 12 is disposed. Thus, during normal or relatively light braking, the braking force is transmitted from the support piece 14 to the brake pad 12 via the metal damper 16 which absorbs the vibration of the brake disk. During intense braking, the metal damper 16 is compressed, and the rim 20 of the support piece 14 that defines the recess 18 comes directly into abutment against the brake lining 12 so as to transmit the braking force.

In a variant, fingers or spikes may be formed on the bottom of the recess 18 so as to come to bear against the brake pad 12 in the same way as the rim 20 does during intense braking. This prevents the damper 16 from being deformed permanently.

In the variant embodiment of FIG. 5, the brake pad 12 is mounted conventionally on the support piece 14 and the metal damper 16 is interposed between the support piece 14 and a clamping member which, in this example, is a piston 22 defining a working chamber 24 in a cylinder 26.

As in the variant embodiment shown in FIG. 4, the metal damper 16 in FIG. 5 is, at rest, received in part in a recess 28 in that end of the piston 22 which faces towards the brake pad 12 and towards the support piece 14, and it projects in part from said recess towards the piece 14.

The device of the invention operates in a manner that follows plainly from the above description: during normal or light braking, the brake pads 12 are clamped against the disk 10 and the metal dampers 16 are then compressed elastically in a direction parallel to the axis of rotation. In this state, they retain an elastic deformation capacity and they are capable of absorbing or of attenuating very considerably any vibration that is higher than their resonant frequency, i.e. vibration whose frequency is greater than in the range 25 Hz to 30 Hz.

During intense braking, the metal dampers 16 of FIGS. 1 to 3 retain the capacity to absorb vibration. In contrast, the metal dampers of FIGS. 4 and 5 no longer have any vibration-absorbing effect when they are compressed sufficiently to be contained in full in the above-mentioned recesses 18, 28.

Naturally, the invention applies to any brake devices using friction lining or pads clamped or applied onto a moving element and it is not limited to brake devices for motor cars.

1. A brake device comprising at least one pad (12) made of a friction material and serving to be pressed by a control member (22) against a moving element (10) such as, for example, a brake disk on a motor vehicle wheel, said brake device being characterized in that it further comprises a damper (16) made of a tangled, intertwined and/or knitted metal wire interposed between the pad (12) and the control member (22).

2. The device according to claim 1, characterized in that the metal damper (16) is a block of tangled, intertwined, or knitted stainless steel wire that is compressed in a press.

3. The device according to claim 2, characterized in that the metal damper (16) is disposed between the pad (12) and a support piece (14) for supporting said pad.

4. The device according to claim 3, characterized in that, at rest, the metal damper (16) is mounted in part inside a recess (18) in the support piece (14) and in part projecting from said piece on the same side as the pad (12).

5. The device according to claim 4, characterized in that the recess (18) is defined by a peripheral rim (20) and/or it is provided with fingers projecting from the bottom of the recess (18).

6. The device according to claim 1, characterized in that the metal damper (16) is disposed between the control member (22) and a support piece (14) for supporting the pad (12).

7. The device according to claim 6, characterized in that, at rest, the metal damper (16) is mounted in part inside a recess (28) in the support piece (14) or in the control member (22) and in part projecting from said recess.

8. The device according to claim 1, characterized in that the metal damper (16) is disposed between the pad (12) and the control member (22), and it forms a support piece for supporting the pad.

9. The device according to claim 1, characterized in that during braking the damper (16) undergoes elastic deformation.
